(19) United States
(12) Patent Application Publication
(10) Pub. No.: US 2005/0027555 A1
(43) Pub. Date: Feb. 3, 2005

(54) Closed-loop control system for recycling products

(76) Inventors: Michael W. Forrest, North Reading, MA (US); David Schneider, Weston, MA (US)

Correspondence Address: George L. Greenfield;Wolf, Greenfield & Sacks, P.C., 600 Atlantic Avenue, Boston, MA, 02210, US

(21) Appl. No.: 10/899,536

(22) Filed: Jul. 26, 2004

Related U.S. Application Data
(60) Provisional application No. 60/491,186, filed on Jul. 30, 2003.

(51) Int. Cl. G06F 17/60; B02C 1/00; B28B 3/06

(52) U.S. Cl. 705/1; 264/140; 264/916

(57) ABSTRACT

A closed-loop control system for recycling products, such as food service ware. The system provides a “pure” stream of the products without major contaminants, which facilitates efficient re-fabrication of the product. The system includes collecting the used product from a selected group of users, isolating the used product from other waste, and delivering the product to a reprocessing center. The used product is washed and pelletized to form recycled pellets, which are combined with virgin pellets in ratios conforming with FDA regulations, to produce new recycled products. These new products are then sold back to the group of users, thus maintaining the system in a closed-loop. The recycled products may include plastic materials, such as polystyrene, polyethylene terephthalate, polypropylene, or high density polyethylene. When any of the above-mentioned plastic materials are in their expanded foam state, the system may be more economically feasible to operate. The group of users may include institutions such as school systems and food management services.

### RELATED APPLICATIONS

This application claims priority under 35 U.S.C. § 119(e) to U.S. Provisional Application Ser. No. 60/491,186, entitled “SINGLE SOLUTION CONTROL SYSTEM FOR RECYCLING POLYSTYRENE PLASTIC FOODSERVICE WARE,” filed on Jul. 30, 2003, which is herein incorporated by reference in its entirety.

### BACKGROUND OF INVENTION

1. Field of Invention

This invention relates to the recycling of products, such as food service ware. In particular, the present invention relates to a closed-loop system and method of recycling plastic material.

2. Discussion of Background

In the late 1980's, pressure was imposed on the polystyrene industry to recycle the most highly visible polystyrene products, namely, food service ware. The industry's usage of chlorofluorocarbons (CFCs) as a blowing agent, along with an uninformed public pressure forced fast food chains to move from polystyrene to alternative packaging that was perceived to be more environmentally friendly such as paperboard and aluminum wraps. This has since been disproved. Paper and aluminum are not only more expensive but non-biodegradable. Foam polystyrene food service ware has become the commodity and economic winner for food service.

In response to the pressure, the polystyrene industry changed to safer blowing agents and spent millions of dollars to develop a recycling infrastructure for improved public relations. Today, non-food service polystyrene packaging comprises almost all of the post-consumer material for recycling. Despite the high level of public attention, the effort to recycle food service packaging has failed because of the high cost to process recycled food service polystyrene and also due to the lack of demand for the recycled material. Recycling food service packaging has also not been economically sustainable due to inefficiencies of hauling and due to the significant incremental costs of cleaning contaminated products.

In order for recycling to be successful with any material, it must be cost effective for all involved. Because food service packaging is generally highly contaminated, and requires cleaning before it can be processed, there are significant costs involved. Additionally, the economics of hauling polystyrene long distances to recycling centers are not favorable because of its light weight. In order to justify selling any recycled material, it has to be cost competitive with virgin material. A surplus of virgin polystyrene resin and no demand for post-consumer food grade resin has kept prices low enough in the last decade, so that the additional costs of recycling food service packaging has made its price too high to be competitive.

Government and public pressure have continued to grow to increase the recycled content in packaging. International pressure is even greater, including the EC Directive introduced in 1994 requiring a minimum recovery of 50-65% of all packaging materials by 2001. In addition, in many major cities in the U.S., reduced landfill space is driving skyrocketing disposal fees, putting additional pressure on source reduction, reuse and recycling.

There have been very few successful commercial ventures to produce high-quality, consistent products from recycled plastic materials. This has resulted in a large quantity of these products being:
(1) Disposed in landfills,
(2) Incinerated for fuel value,
(3) Recycled into lower-value forms/applications (e.g., polyethylene terephthalate (PET) bottles into fiberfill, polyethylene (PE) milk bottles into T-shirt bags, polypropylene (PP) into trash receptacles, etc.), and
(4) De-polymerizing the plastic into its constituent components (monomers/oligomers) which can be then reconstituted into the original polymer.

In all the above-listed cases, the value of the recycled material is greatly reduced by the “contamination” of the recycled plastic with “different” materials; these materials may include:
(1) A like-polymer with different composition (e.g., a polyethylene with different molecular weight range, additive composition, etc.),
(2) Dissimilar polymer (e.g., polystyrene with polyethylene), and
(3) Other materials (metals, paper, food, dirt, etc.).

### SUMMARY OF INVENTION

The present invention embodies a system to produce truly “closed loop” recycled products which can be reused in higher-value applications, creating the following benefits throughout the system:
(1) Reduction on the amount of plastic waste to landfills,
(2) Provide a “pure” stream of plastic products without major contaminants, which facilitate efficient re-use into higher-value plastic components (e.g., polystyrene plastics can be re-fabricated into polystyrene plates for food service ware for food contact),
(3) Maintain the value of the recycled resin to be equal to the value of virgin resin,
(4) Waste disposal cost can be reduced 50%+,
(5) Provide employment for skilled/semi-skilled labor (in some areas of the recycling/converting process, handicapped labor can be involved in the sorting/cleaning/pelletizing of the plastic),
(6) Educational benefits can also be gained if some of the collecting/cleaning/converting process is co-located with an educational facility (e.g., school or vocational school), and curriculums can be developed within various school departments to incorporate the recycling system into math and science classes, and
(7) Provide an economic solution of a sustainable project fostered from the institution's savings from costly waste management fees combined with the value of the recycled material.

An object of the present invention is to provide a “closed-loop” system that is safe for re-using recycled material for single service food contact.

FDA Regulations specify what constitutes “food grade” polystyrene which must be used for polystyrene food service ware. Under current FDA Regulations, recycled food service ware products should not contain more than 25% of post-consumer recycled material. To assure compliance with these regulations, in accordance with one embodiment of the present invention, manufacturers of products in the closed-loop system certify that the material they are using complies, and all suppliers to the sources must verify this information before the purchase of their materials. Thus, “food grade” material is assured.

In accordance with another aspect of the present invention, polystyrene products are sorted from food trash, bagged and brought to the recycling facility, where they are again sorted to assure that other materials or food are not present before recycling. Care is taken to assure that those materials saved are the ones actually used at the specific food service operation (vs. other plastic products brought in from home or outside which may not be made of polystyrene).

In accordance with another aspect of this invention, the new products with recycled content are resold to the same sources where the used material was collected. This continuation of virgin manufacture, use, collection, recycling and re-use “closes the loop” and fully satisfies the requirement for single service food contact.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow diagram showing the various steps in the closed loop system for performing the recycling operation in accordance with the present invention; and

FIG. 2 is a diagrammatic illustration of an application of the present invention in a community including a school system and additional institutions geographically proximate thereto.

### DETAILED DESCRIPTION

This invention is not limited in its application to the details of construction and the procedures of steps of the method set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

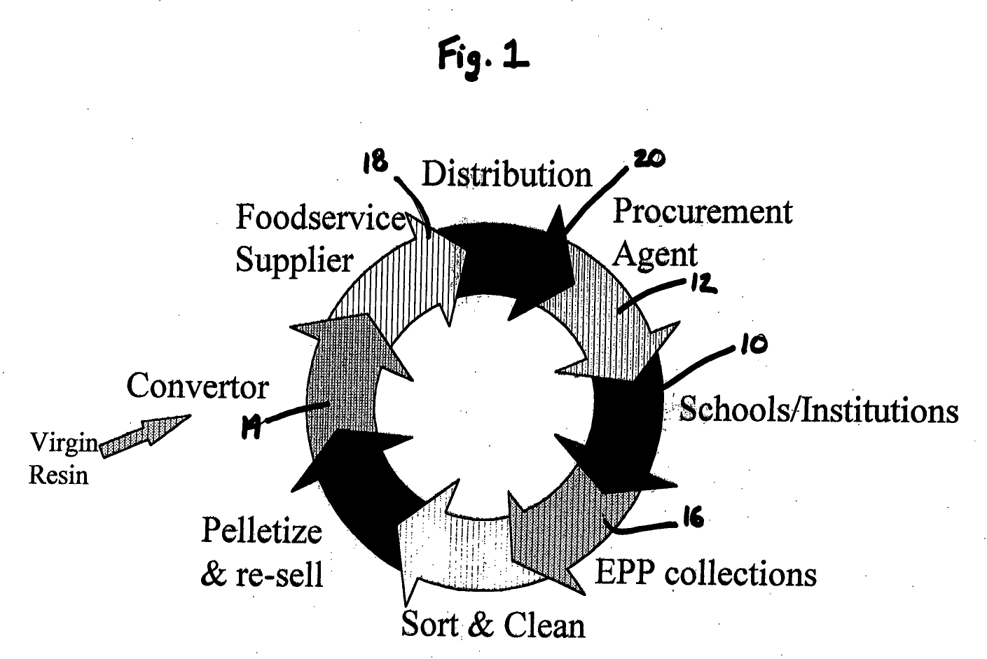

FIG. 1 illustrates a closed loop continuous system for recycling food service ware, such as expanded polystyrene dishes and trays used in institutions, such as public schools, colleges, universities, industrial catering, etc. In this illustration, a number of participants are identified, such as schools and other institutions, that employ disposable food service ware at 10, a system coordinator or procurement agent 12 may oversee the collection and conversion of the waste products, and the converter 14 utilizes the washed and pelletized product and mixes it with additional designated virgin raw material to manufacture the new food service ware. Various functions are performed by each of the participants and some of their respective tasks may be carried out by one or more entities. From the converter 14, newly manufactured food service ware is ultimately supplied back to the schools or institutions 10 where the cycle is repeated over and over again. During each cycle of the system, additional virgin material is combined with the converted used service ware. In one embodiment, the newly manufactured food service ware is transported from the converter 14 to a distributor 20, and then to the procurement agent 12, to meet the supply demands of the school or institution 10. In some embodiments, the recycled material may be tested to detect any extractives or microbial contamination. This testing may occur once the finished product is produced and/or may also occur after the used food service ware is cleaned. The various steps in the cycle are described in greater detail below.

As indicated, the source of the used service ware is the institution, such as schools, industrial caterers, or other sources that participate in the program. These disposable food service ware users only need collectively to use the disposable food service ware in substantial quantities to reach a critical mass to justify the investment in the system to make it economically feasible both for the institution and for the others that participate in it. In one embodiment, the group in the closed-loop system that contributes to the recycling includes at least 120,000 individuals that use disposable food service ware daily. Such a system may use about 350,000 pounds of disposable food service ware in one year. It was determined that a system of this size is a minimum threshold weight to having an economically viable system. Thus, a system including a larger amount of disposable food service ware would be profitable.

The used disposable food service ware is collected in designated bins, barrels, bags, or other suitable containers that are physically separate from other containers that receive waste other than that in which food is served by the institution. Thus, any materials such as bags, whether of paper, or other material brought to the institution by the individuals that participate in the food service program should not be deposited in the containers that are specially designated to receive the used food service ware provided by the institution.

As represented at 16 in the loop of FIG. 1, the used food service ware, or environmentally preferred product (EPP), is collected and transported to a facility where the ware is sorted, washed, ground, and pelletized. The location of the facility where that occurs should be geographically near, if not at the institution, from where the dishes and trays are collected so as to minimize transportation costs. The cost of operating the facility where the ware is sorted, washed, ground, and pelletized may be borne by the participating institution or institutions in the system. In one embodiment, the equipment may be supplied and owned by the entity that coordinates the program and overseas the participation of all those involved in it.

A value may be assigned to the recycled pellets produced in the closed-loop system. In one embodiment, the value assigned to a pound of recycled pellets is equivalent to the value of a pound of virgin pellets. However, in other embodiments, the value assigned to recycled pellets may be more or less than the value of the virgin pellets. Once the value of the recycled pellets produced is determined, this value may be applied towards the cost of the equipment for making the recycled pellets. Thus, in one embodiment, if the total value assigned to the recycled pellets produced equals the total cost to manufacture the pellets, then the system costs breaks even, and the added value of recycling pays for itself. However, when factoring in the decrease in disposal costs, as well as any other miscellaneous cost savings, the closed-loop system may be profitable.

It should be appreciated that, although some of the above mentioned embodiments describe closed-loop systems for recycling polystyrene products, the method and system of the present invention is not limited for use with any particular type of material. The present invention may also be used to recycle other plastic materials in general, if foamed. More specifically, the present invention may be used to remanufacture polypropylene, high density polyethylene, polyethylene terephthalate, and the like. The volume, however, must be large enough to make the system economically feasible.

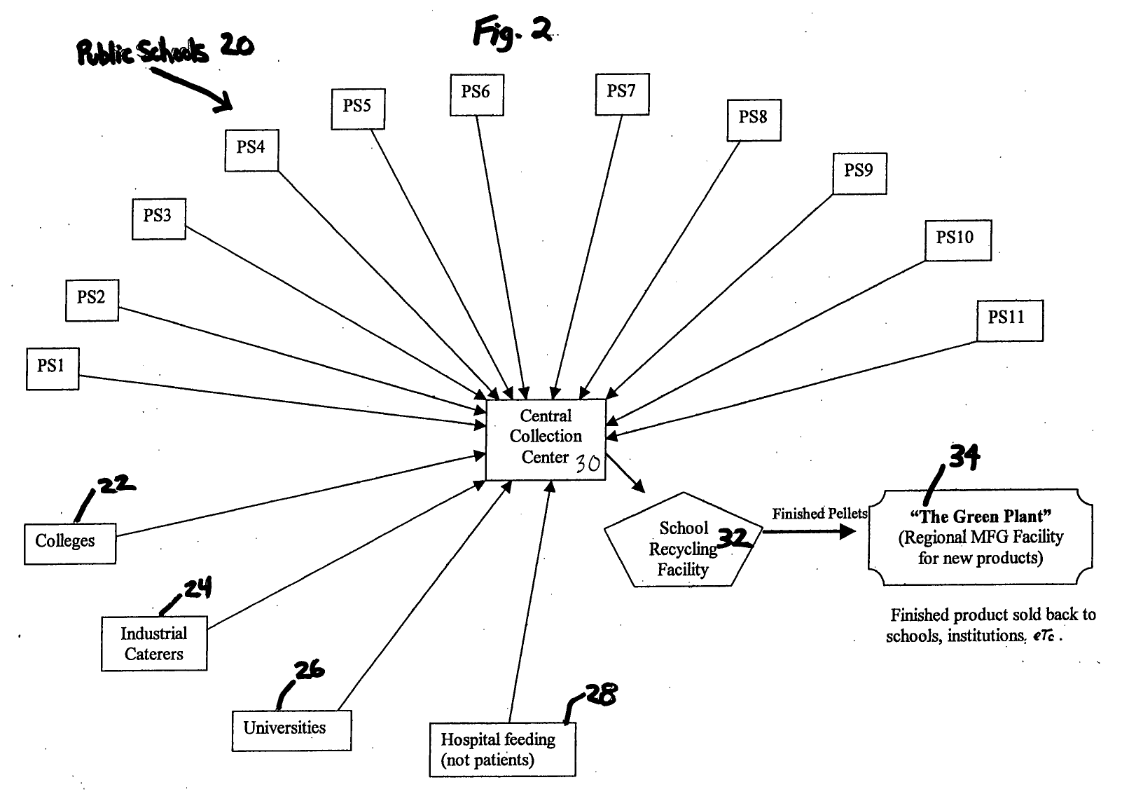

In one embodiment of the present invention, the group of users includes a school system. As illustrated in FIG. 2, a plurality of schools 20 (public and/or private), colleges 22, industrial caterers 24, universities 26, and/or hospitals 28 form a group that collectively uses a sizable quantity of disposable products, such as foam polystyrene. All of the members of the group collect and transport their used polystyrene food service, ware products to a central collection center 30. When an institution such as a hospital is part of the group of end users, it may be beneficial to only collect used food service ware products from the cafeteria, and not from any patients, as this may require additional cleaning and testing of the recycled material which may drive up manufacturing costs. From the central collection center 30, the used polystyrene may be transported to the recycling facility 32. In one embodiment, the recycling facility is located at one of the group end users, such as at one of the schools 20. This enables students to become involved in the recycling process, which may instill the benefits of recycling into students at a young age. Once the used polystyrene is sorted, cleaned and pelletized, the recycled polystyrene pellets may be transported to a regional processing facility 34 to further manufacture the pellets into new polystyrene products. The regional manufacturing facility 34 combines the recycled polystyrene pellets with virgin polystyrene pellets. This mixture may further be combined with pre-consumer polystyrene scrap to further recycle, reuse, and reduce costs. Once the new recycled polystyrene products, such as food service ware products, are manufactured, the finished product is sold back to the original group of users.

In order for recycled materials to be used in food contact applications, they must comply with the Federal Food, Drug and Cosmetic Act and the Food Additive regulations that have resulted under the Act. Thus, food safety must always be a paramount consideration with respect to the use of recycled plastics in food contact applications. The following three factors are aspects of every recycled material application which must be considered by the user and the manufacturer when considering food safety.
(1) Source Control—The ability to control the source of the material is critical. The more control exercised over the supply of the recycled material, the less concern over possible contamination.
(2) Efficiency of the Process—The capability of the process to remove contaminants, such as food, and fully process the material is also critical. If the process is not efficient, it may not be safe to use the finished product.
(3) Conditions of Use—The less severe the conditions of use for the product to be recycled, the smaller the likelihood of the migration of contamination. Restricting the material to be recycled to food contact during single service use for institutional feeding, rather than further including products used for food storage, may help to limit such contamination.

The closed-loop system of the present invention effectively recycles food service ware in a manner that addresses these factors, such that food safety concerns are minimized. The closed-loop itself provides a large amount of control over the source of the recycled material. Further, the steps of cleaning and then testing the material for contamination enable the system to efficiently remove any contamination. Finally, the single use food service ware market provides the desirable less severe conditions of use.

As discussed above, current Federal Regulations specify that the recycled food service ware products should not contain more than 25% of post-consumer recycled material. In one embodiment, approximately 10%-25% of the recycled polystyrene products contain post-consumer used polystyrene, and approximately 50%-55% of the recycled polystyrene products is virgin polystyrene. The remaining percentage (20%-40%) of the recycled polystyrene products may include pre-consumer recycled polystyrene, such as clean industrial scrap and trim, accumulated when manufacturing new service ware.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A closed loop control system for making economically feasible, recycled polystyrene single use food service ware, comprising the steps of:
organizing a number of entities in a group that together use sizable quantities of disposable polystyrene food service ware;
collecting the used service ware from the group, while avoiding mixing the used service ware with other service ware polystyrene products that did not emanate from the polystyrene service ware of the group;
establishing a facility for washing, grinding and pelletizing the used polystyrene food service ware;
transferring the pelletized used polystyrene to an entity that combines the pelletized used polystyrene with virgin polystyrene in proportions allowed under government regulations and arranges for the conversion of the mixture to recycled polystyrene food service ware, and for the sale of the service ware to the entities in the group;
and continuing the cycle over again.

2. The system as described in claim 1, wherein at least one entity in the group operates the facility for washing, grinding and pelletizing the used polystyrene.

3. The system as described in claim 1, wherein the group is credited an amount predicated upon the value per pound of the virgin polystyrene pellets and the pounds of the pellets made from the used polystyrene provided by the group.

4. The system as described in claim 1, wherein the group is made up of one or more entities that each feed a large number of individuals.

5. The system as described in claim 2, wherein the group is made up of one or more educational facilities.

6. The system as described in claim 5, wherein the group is a large school system.

7. The system as described in claim 4, wherein the group collectively feeds at least 120,000 individuals.

8. The system as described in claim 1, wherein the sizable quantity of disposable polystyrene food service ware used within the closed loop system in one year weighs at least 350,000 pounds.

9. A closed loop control system for making economically feasible, recycled polystyrene single use food service ware, comprising the steps of:
identifying an entity to coordinate the performance of the parties that perform the various steps of the system;
organizing a group of end users that collectively use sizable quantities of disposable polystyrene food service ware;
collecting the used food service ware of the group, while avoiding mixing that service ware with other products that did not emanate from the group, thereby eliminating the ordinary costs of disposing of the used ware;
establishing a hub facility at or near to the group, for washing, grinding and pelletizing the used polystyrene food service ware and producing recycled polystyrene pellets;
charging the cost of operation of the facility to the end users of the group,
benchmarking the value of the recycled pellets at that of virgin pelletized material;
applying the difference between the group's costs to produce the recycled pellets and the market price of virgin pellets, toward the cost of equipment for making the recycled pellets;
transferring by the entity coordinating the operation, the recycled polystyrene pellets to a designated fabricator that combines the recycled polystyrene pellets with virgin polystyrene in proportions allowed under government regulations and converts the combined pellets to food service ware for sale of the ware to the said end users in the group;
and continuing the cycle over again.

10. The system as described in claim 9, wherein the recycled polystyrene is up to 25% of the total mixture of the converted food service ware.

11. The system as described in claim 9, wherein the recycled polystyrene is between 10 to 25% of the total mixture of the converted food service ware.

12. The system as described in claim 11, wherein the virgin polystyrene is between 50 to 55% of the total mixture, and the remaining percentage of the mixture includes pre-consumer polystyrene scrap.

13. The system as described in claim 9, wherein the group of end users includes a school system.

14. The system as described in claim 9, further comprising the step of testing the recycled polystyrene for contamination.

15. A closed-loop control system for recycling single use food service ware comprising:
organizing a number of entities that use disposable food service ware;
collecting the used food service ware from the entities, isolating the service ware from other waste and delivering the ware to a reprocessing center;
washing and pelletizing the delivered food service ware to form recycled pellets;
combining the pellets with virgin pellets in ratios conforming with FDA regulations and producing new food service articles;
and selling the new food service articles to the entities that comprised the sources of the used food service ware.

16. The system as described in claim 15, wherein the food service ware comprises expanded polystyrene.

17. The system as described in claim 15, wherein the entities are schools and/or institutions.

18. The system as described in claim 16, wherein the recycled polystyrene is up to 25% of the mixture of recycled and virgin polystyrene.

19. The system as described in claim 15, wherein the entities gather the used food service items in designated waste containers.

20. The system as described in claim 15, wherein the food service ware comprises expanded plastic.

21. The system as described in claim 15, wherein the food service ware comprises expanded polypropylene.

22. The system as described in claim 15, wherein the food service ware comprises expanded high density polyethylene.

23. The system as described in claim 15, wherein the food service ware comprises expanded polyethylene terephthalate.
